(19) United States
(12) Patent Application Publication
(10) Pub. No.: US 2006/0174147 A1
(43) Pub. Date: Aug. 3, 2006

(54) Electronic equipment, sensor, method and program for controlling electronic equipment

(75) Inventors: Kensuke Uehara, Fnabashi-Shi (JP); Tomonori Kobayashi, Tokyo (JP); Wataru Takahashi, Chiba-Shi (JP); Mikiko Arima, Tokyo (JP)

Correspondence Address: LENOVO (US) IP Law, Mail Stop ZHHA/B675/PO Box 12195, 3039 Cornwallis Road, RTP, NC, 27709-2195, US

(73) Assignee: Lenovo (Singapore) Pte. Ltd., Singapore (SG)

(21) Appl. No.: 11/271,303

(22) Filed: Nov. 10, 2005

(30) Foreign Application Priority Data
Nov. 11, 2004 (JP) 2004-327553

(51) Int. Cl. G06F 1/26

(52) U.S. Cl. 713/320

(57) ABSTRACT

Electronic equipment includes two or more operating modes including a normal mode and a security mode and/or power saving mode. The electronic equipment comprises input devices which input information into the electronic equipment by a person performing an operation which is external to the electronic equipment, a sensor which is disposed in a rest portion of the input devices and which generates a predetermined signal in response to a detection that a part of the body of the person performing the operation rests on the rest portion, and a signal generator which generates a signal to instruct the electronic equipment not to shift to the security mode and/or power savings mode based on the predetermined signal generated by the sensor.

### FIELD OF THE INVENTION

The present invention generally relates to a controlling method of electronic equipment such as a computer terminal. The present invention relates more specifically to a method and a program product for controlling electronic equipment in consideration of a behavior of an operator of the electronic equipment, electronic equipment implementing the same, and a senor connected to the electronic equipment.

### BACKGROUND

The screen lock function (a screen saver with a lock function, Non-Patent Document 1) and the standby function or the halt function (Non-Patent Document 2) are used to enhance security and save electronic consumption of a computer terminal.

Specifically, a computer terminal operating in a normal mode, in which the computer terminal accepts information inputted by a user, activates the screen lock function and enters into the security mode, in which the computer terminal does not accept any input by a user, or activates the standby function or the half function and enters into the power saving mode, when a timer clocks a time preset by a user, during which the user has not inputted any information.

Once the computer terminal enters into the security mode, the user is required to be authorized by inputting a password or the like in order to return to the normal mode. Once the computer terminal enters into the power saving mode, the computer terminal operates in a power saving state such as a power off state until it returns to the normal mode through a reset action by a predetermined operation.

It is understood that enhancement of security and reduction of electronic consumption can be realized when a user leaves a desk while a computer terminal is being activated, by using the screen lock function and the standby function or the halt function. The standby function or the halt function may be accompanied by the lock function using a password. The standby function or the halt function accompanied by the lock function realizes enhancement of security and reduction of electronic consumption.

[Non-Patent Document 1] “Set screen saver”, Microsoft Co., Ltd., support technical information 882775, “searched on Oct. 6, 2004”, Internet http://support.microsoft.com/default.aspx?scid=kb;ja;882775 [Non-Patent Document 2] “make the power to standby/halt state, when the computer is not in use”, Microsoft Co., Ltd., support technical information 882795, “searched on Oct. 6, 2004”, Internet http://support.microsoft.com/default.aspx?scid=kb;ja;882795

For example, when creating an electronic document by operating a computer terminal, users often rest their palms on the rest portion of an input device, such as a keyboard and a mouse, to perform thinking tasks (such as elaboration of sentences). If a short time is set for the duration of time before a shift is performed to the security mode or power saving mode, even when the user sits in front of the computer terminal, the computer terminal can shift to the security mode or power saving mode. As a result, the user can be forced to have an operational burden, such as authentication for returning from the security mode and waiting for returning from the power saving mode; these operations are not originally required.

On the contrary, in order to avoid the above burden, a longer time can be set for the duration of time before a shift is performed to the security mode or power saving mode. With such setting, however, the terminal device will operate on the normal mode for a considerable period of time even after the user leaves the desk: this is not preferable in terms of security or power consumption.

The present invention intends to provide a method and a program for controlling electronic equipment, the electronic equipment, and a sensor to solve the above mentioned problems.

### SUMMARY OF THE INVENTION

In order to solve the abovementioned problem, according to a first aspect of the present invention, electronic equipment which operates on two or more kinds of modes including a normal mode and a security mode and/or power saving mode and includes an input device for inputting information into the electronic equipment by a person performing an operation, the electronic equipment comprising: a sensor disposed in a rest portion of the input device, for generating a predetermined signal in response to a detection that a part of the body of the person performing the operation rests on the rest portion, and a signal generator for generating a signal to instruct the electronic equipment not to shift to the security mode and/or power saving mode is provided based on the predetermined signal generated by the sensor.

According to the second aspect of the present invention, a sensor connected to electronic equipment operating on two or more kinds of modes including normal mode and security mode and/or power saving mode, and disposed in a rest portion of means for inputting information into the electronic equipment by a person performing operation, the sensor comprising: means for generating a predetermined signal in response that it is detected that a part of the body of the person performing operation rests on the rest portion; and means for sending the generated signal to generate a signal to instruct the electronic equipment not to shift to the security mode and/or power saving mode, based on the generated predetermined signal is provided.

According to the third aspect of the present invention, a method of controlling electronic equipment operating on two or more kinds of modes including normal mode and security mode and/or power saving mode, wherein the electronic equipment includes means for inputting information into the electronic equipment by a person performing operation, the method comprising: a step of, in a sensor provided in a rest portion of the inputting means, generating a predetermined signal, in response that it is detected that a part of the body of the person performing operation rests on the rest portion; and a step of generating a signal to instruct the electronic equipment not to shift to the security mode and/or power saving mode, based on the predetermined signal generated by the sensor is provided.

According to the fourth aspect of the present invention, a program product for controlling electronic equipment operating on two or more kinds of modes including normal mode and security mode and/or power saving mode, wherein the electronic equipment includes means for inputting information into the electronic equipment by a person performing operation, the program causing the electronic equipment to perform: a step of, in a sensor provided in a rest portion of the inputting means, generating a predetermined signal, in response that it is detected that a part of the body of the person performing operation rests on the rest portion; and a step of generating a signal to instruct the electronic equipment not to shift to the security mode and/or power saving mode, based on the predetermined signal generated by the sensor is provided.

The abovementioned overview of the present invention does not list all the features necessary for the present invention. It should be noted that the sub combinations of the features may be included in the present invention.

According to the present invention, electronic equipment, which operates in two or more modes including a normal mode, a security mode and/or a power saving mode, is effectively controlled.

Preferred embodiments for implementing the present invention will be described in detail with reference to diagrams. None of the specific embodiments limit the invention outlined in the claims nor are all the combinations of features described in the embodiments necessary for the solution of the invention.

The present invention can be implemented in many different aspects and should not be construed as limited to what described in the embodiments. It should be noted that all the combinations of features described in the embodiments are necessary for the solution of the invention. Like elements are denoted by like numbers through the entire description of the embodiments.

In the embodiments below, equipment and a method are mainly described. It is apparent to those skilled in the art that a part of the present invention can be implemented as a program which can be used in a computer. Therefore, the present invention can be implemented as hardware, software or a combination of software and hardware. The program can be stored in any computer readable medium such as a hard disc, DVD-ROM, CD-ROM, an optical medium or a magnetic storage device.

A “rest portion” refers to a space or an area for an operator of an input device for operating electronic equipment, such as a keyboard, a mouse or a remote controller, to rest a part of the body while operating the electronic equipment or suspending the operation. A “normal mode” refers to a state of electronic equipment for accepting operation of an operator of the electronic equipment. A “security mode” refers to a state of not accepting operation of a user for inputting information into operated equipment until the operator performs authentication. A “power saving” mode refers to a state of operating with power consumption less than that for a normal mode (including a power off state) and a state of not accepting user's operation and requiring a predetermined recovering operation to accept user's operation.

FIG. 1 is a high-level block diagram of a palm rest 100 according to the first embodiment of the present invention. The palm rest 100 is placed next to the keyboard at the user's side for relieving fatigue of the user's hands. The palm rest 100 is a pad or a cushion used for supporting palms or writs.

The palm rest 100 according to the first embodiment includes a body 101. A piezoelectric sensor 102 is embedded in the body 101. The piezoelectric sensor 102 generates predetermined current in response to receiving a pressure when a palm or the like is placed on the body 101 of the palm rest 100. The current generated by the piezoelectric sensor 102 is converted into the USB signal form at a converter 103 and received in a computer terminal connected with a USB terminal 105 via a USB cable 104.

FIG. 2 is a diagram showing a system according to the first embodiment of the present invention. The palm rest 100 of the first embodiment of the present invention is connected with a USB port of the computer terminal 200. A keyboard 13 and a mouse 14 are connected to PS/2 terminals on the computer terminal 200. A display device 15, which is a well-known CRT monitor, is connected to an RGB output terminal on the computer terminal 200. The palm rest 100 is placed and used next to the keyboard 13 at the user's side.

A user operating the computer terminal 200 inputs necessary information to documentation software such as Microsoft® Word by operating the keyboard 13 and the mouse 14. The user may edit the created document by checking a layout or the like of the document on the display device 15.

When the user operates the keyboard 13, the user places his palms or writs on the palm rest 100. While the palms or the writs of the user are placed on the palm rest current is generated at the piezoelectric sensor by the pressure imposed by the hands' weight. Predetermined signals generated by the converter 103 are sent to the computer terminal 200. It should be noted that a user often places his palms or writs on the palm rest 100 while thinking in working on his manuscript to improve the wording by viewing on the display device 15. Even in such a case, the predetermined signals are continued to be sent from the palm rest 100 to the computer terminal 200.

FIG. 3 is a diagram illustrating an example of a hardware configuration of the computer terminal 200 preferable to connect with the palm rest 100 according to the first embodiment of the present invention. The computer device 200 includes a CPU (central processing unit) 1 and main memory 3 connected to a bus 2. Removable storage (an external storage system which can change storage media) such as a hard disc device 6 and a CR-ROM device 7 is connected to the bus 2 via an IDE controller 5. It is apparent to those skilled in the art that the other types of removable storage such as a flexible disc device, an MO device, and a DVD-ROM device can be connected to the bus 2 as well as or instead of the CD-ROM device 7.

A storage medium such as a flexible disc, an MO, CD-ROM, or DVD-ROM is inserted into the removable storage. The storage medium or the hard disc device 6 or the ROM 4 can store a computer program code for instructing a CPU or the like in cooperation with an operating system to implement the present invention. The computer program is executed by being loaded on main memory 4. The computer program can be compressed and divided into plural parts to be stored on plural media.

The computer terminal 200 receives input from a user interface device such as the keyboard 13 or the mouse 14 via a keyboard/mouse controller 9. The computer terminal 200 is connected to the display device 15 for presenting visual data to a user via a video controller 10. The computer device 200 has a USB port 8 for connecting various USB appliances 12. The palm rest 100 according to the first embodiment of the present invention is connected to the computer terminal 200 via the USB port 8.

The computer terminal 200 can connect to a network via a network adapter 11 (an Ethernet®, card or a token ring card) to communicate with the other computers or the like. The computer terminal 200 can connect with a printer via a parallel port or with a modem via a serial port, though the ports are not shown.

From the above description, it will be easily understood that the computer terminal 200 according to the first embodiment of the present invention is realized by information processing equipment such as a main frame, a workstation, a common personal computer (PC) or the like or combinations of them. The components are merely examples, however, and all the components are not necessary for the present invention.

Those skilled in the art can easily conceive various modifications such that: various hardware configurations of the computer device used to implement the present invention can be implemented by combining plural machines and allocating functions among the combinations. It is a matter of course that the modifications are included in the spirit of the present invention.

The computer terminal 200 can use Windows® operating system provided from Microsoft Corporation, AIX® provided from International Business Machines Corporation, MacOS® provided from Apple Computer Incorporated, or what supporting a GUI multi-window environment such as Linux® as an operating system.

The computer terminal 200 can also use what in a character based environment such as PC-DOS provided from International Business Machines Corporation or MS-DOS provided from Microsoft Corporation as an operation system. A server 300 can use a built-in operating system for a network computer such as a real time OS including Open, the OS provided from International Business Machines Corporation and Vx Works from Wind River Systems. Inc. or Java® OS.

It can be understood from the above description that the computer device is not limited to a particular operating system environment.

FIG. 4 is a functional block diagram of a system of the first embodiment of the present invention. Each component shown in the functional block diagram of FIG. 4 can be realized by hardware resources and software cooperating with each other in a computer with a hardware configuration exemplified in FIG. 3.

The system of the present invention includes the computer terminal 200, the palm rest 100, the keyboard 13, the mouse 14 and the display device 15 connected to the computer terminal 200. As the keyboard 13, the mouse 14 and the display device 15 are quite well known input/output devices, description of them will be omitted here.

The palm rest 100 is physically placed to the user's side next to the keyboard 13. When a user operates the keyboard, palms or writs, which are parts of the user's body, are placed on the palm rest 100. The palm rest 100 has a sensor 102 which generates current in response to weight of the hands. The generated current is converted into predetermined signals in the USB signal form and sent to the computer terminal 200. The computer terminal 200 can recognize the presence of a part of the user's body on the palm rest 100 based on the predetermined signals.

The computer terminal 200 includes an input/output interface 201, mode setting means 202, mode switching means 203, a timer 204, a screen saver controller 205, a power controller 206 and an application 207.

The input/output interface 201 has a function of communicating signals received from an input device such as the palm rest 100, the keyboard 13 or the mouse 14 to each component in the computer terminal 200. The input/output interface 201 has a function of sending out the signals from each component in the computer terminal 200 to an output device such as the display device 15.

The mode setting means 202 has a function of accepting a setting-value relating to the mode, which the computer terminal 200 can use, from a user and store the setting value. The setting values stored in the mode setting means 202 may include conditions for shifting modes (for example, a time period during which no input/output signal is detected as a condition for shifting to the security mode).

The mode switching means 203 has a function of monitoring the computer terminal 200 or a device or the like connected to the computer terminal 200, and generating an instruction to shift the computer terminal 200 to a predetermined mode, when it references the shifting conditions stored in the mode setting means 202 and a monitored object is matched with a particular shifting condition.

The timer 204 has a function of clocking passage of time and is used for determining whether the mode switching means 203 satisfies a shifting condition. Specifically, in the first embodiment of the present invention, the timer 204 functions as (A) a screen saver activating timer for clocking a time passed from when the computer device 200 starts monitoring of signals from an input device such as the keyboard 13 or the mouse 14 or the palm rest 100 in a normal mode and as (B) a standby/halting function activating timer for clocking a time passed from when the computer device 200 starts monitoring of signals from an input device such as the keyboard 13 or the mouse 14 or the palm rest 100 in a normal mode.

The screen saver controller 205 has a function of storing data of screen savers and activating a previously designated screen saver in response to an instruction from the mode switching means 203. The screen saver controller 205 also has a function of terminating a screen saver after the screen saver is activated, when it receives input of a password from a user who wants to return to a normal mode and determines that the correct password is inputted.

The power controller 206 has a function of controlling a power source or the like and shifting to the power-saving mode (ON/OFF) in response to an instruction from the mode switching means 203. The power controller 206 also has a function of shifting the computer terminal 200 to a normal mode after the computer terminal 200 is shifted to the power saving mode, when it receives input of a password from a user who wants to return to a normal mode and determines that the correct password is inputted.

FIG. 5 is a flowchart showing a flow of setting operation of parameters relating to shifting conditions to the security mode, the power saving mode, or the security mode/power saving mode (these modes are collectively called “security mode and/or power saving mode in this specification) in a system of the first embodiment of the present invention. The operation starts at step 501. At step 502, the mode setting means 202 receives a password used for authentication required by the system to return from the security mode and/or power saving mode to a normal mode from a user.

At step 503, the mode setting means 202 receives a selection whether or not to use the screen saver function with a password lock function (screen lock function) from a user. If it is determined that the user selects not to use the screen saver function at step 504, the operation proceeds to step 506 according to the arrow No.

If it is determined that the user selects to use the screen saver function at step 504, the operation proceeds to step 505 according to the arrow Yes. At step 505, a prompt is displayed on the display device for asking the user to input the time period from the starting of the monitoring signals from an input device such as a keyboard or a mouse or the palm rest 100 needed for signals from the monitored object to be not detected to activate the screen saver (hereinafter referred to as “screen saver activating time”).

In the first embodiment of the present invention, at step 505, different values can be set for (A) a time period for no signal being detected from the input device to activate a screen saver (hereinafter referred to as “a first screen saver activating time”) and (B) a time period for no signal being detected from the palm rest to activate a screen saver (hereinafter referred to as “a second screen saver activating time”). For example, a user is more likely away from the desk in the case that no signal is detected from a palm rest 10 than in the case that no signal is detected from the keyboard 13. In order to take such a circumstance into consideration, the first screen saver activating time can be set to a bigger value than that of the second screen saver activating time. When parameters of screen saver activating times have been inputted, the operation proceeds to step 506.

At step 506, the mode setting means 202 receives a selection whether or not, to use the standby function or the halt function from the user. If it is determined that the user selects not to use the standby function or the halt function at step 507, the operation proceeds to step 509 according to the arrow No and the parameter setting operation ends.

If it is determined that the user selects to use the standby function or the halt function at step 507, the operation proceeds to step 508 according to the arrow Yes. At step 508, a prompt is displayed on the display device for asking the user to input the time period from the starting of the monitoring signals from an input device such as a keyboard or a mouse or the palm rest 100 needed for signals from the monitored object to be not detected to activate the standby function or the halt function (hereinafter referred to as “standby/halt function activating time”) as in step 505.

In the first embodiment of the present invention, at step 508, different values can be set for (A) a time period for no signal being detected from the input device to activate the standby function or the halt function (hereinafter referred to as “a first standby/halt function activating time”) and (B) a time period for no signal being detected from the palm rest to activate the standby function or the halt function (hereinafter referred to as “a second standby/halt function activating time”) as in step 505. When parameters of standby/halt function activating times have been inputted, the operation proceeds to step 506 and the parameter setting operation ends.

The password, ON/OFF for each of the screen saver function and the standby function or the halt function, the screen saver activating times and the standby/halt functions activating times, which are inputted from a user, are securely stored in storage of the mode setting means 202 of the computer terminal 200.

FIG. 6 is a flowchart showing operation of a system according to the first embodiment of the present invention. In the flowchart of FIG. 6, it is assumed that both the screen saver function and the standby function or the halt function are ON. It is assumed in the first embodiment of the present invention, if any signal is received from neither an input device nor the palm rest 100 for a certain time period in a normal mode, the normal mode is shifted into the security mode; and if any signal is received from neither an input device nor the palm rest 100 for a certain time period in a security mode, the security mode is shifted into the power saving mode.

The operation starts at the step 601 where the computer terminal 200 is in a normal mode. At step 602, the system monitors signals from an input device such as the keyboard 13 and the mouse 14 and signals from the sensor 102 of the palm rest 100. At step 602, a screen saver activating timer realized by using the timer 204 clocks time passed from the starting of the monitoring.

The operation proceeds to step 603 where determination is made whether a signal from an input device or a signal from the sensor 102 is detected within the screen saver activating time stored in the storage of the mode setting means 202. If a signal is detected within the screen saver activating time, the operation proceeds to step 604 according to the arrow Yes. At step 604, the screen saver activating timer is reset and the operation returns to step 602 where the system starts monitoring again. If a signal is not detected within the screen saver activating time at step 603, the operation proceeds to step 605 according to the arrow No where the screen saver is activated and the mode is shifted into the security mode.

If different values are set for the first screen saver activating time and the second screen saver activating time and either of the conditions of (A) no signal is detected from an input device within the first screen saver activating time or (B) no signal is detected from the palm rest 100 within the second screen saver activating time is satisfied at step 603, the operation proceeds to step 605 according to the arrow No where the screen saver is activated. In contrast, if either of the conditions of (A) a signal is detected from an input device within the first screen saver activating time or (B) a signal is detected from the palm rest 100 within the second screen saver activating time is satisfied, the operation proceeds to step 604 according to the arrow Yes where the screen saver activating timer is reset.

If the screen saver is activated at step 605 and the mode is shifted to the security mode, the operation proceeds to the step 606. At the step 606, the system monitors a signal from the input device and a signal from the sensor 102. At 606, the standby/halt function activating timer realized by using the timer 204 clocks time passed from the starting of the monitoring.

The operation proceeds to the step 607 where determination is made whether a signal from an input device or a signal from the sensor 102 is detected within the standby/halt function activating time stored in storage of the mode setting means 202. If a signal is detected within the standby/halt function activating time, the operation proceeds to the step 608 according to the arrow Yes.

At step 608, determination is made whether the detected signal is from the sensor or from an input device. If the detected signal is from the sensor, it can be assumed that the user wants to shift into the standby state or the halt state but still does not want to return to a normal mode. Therefore, the operation proceeds to step 609 according to the arrow No where the standby/halt function activating timer is reset, then to step 606 where the system starts monitoring again.

If the detected signal is determined from an input device at step 608, it can be assumed that the user wants to return to a normal mode. Therefore, the operation proceeds to step 610 according to the arrow Yes where the system asks the user to input a password for authentication for returning to a normal mode. Determination is made at step 611 for whether or not the password inputted at the step 610 matches the password stored in storage of the mode setting means 202. If the passwords do not match at step 611, the operation returns to step 610 according to the arrow No. where the system prompts the user to input a password again. If the passwords are determined to match at step 611, the system is returned to a normal mode. Then the operation proceeds to step 602 according to the arrow Yes where the system starts monitoring again.

Returning to the description of the step 607 and if no signal is detected within the standby/halt function activating time, the operation proceeds to step 612 according to the arrow No where the system activates the standby function or the halt function, saves the current system state of the computer terminal 200 in a hard disc and powers off the computer terminal 200, and the computer terminal 200 is shifted to the power saving mode.

The operation proceeds to the step 613. If a power supply button is turned on as an action for returning from the power saving mode, the system reboots at step 614. When the system reboots at step 614, the operation proceeds to step 610 where the system asks the user to input a password for authentication for returning the system to a normal mode. Determination is made at step 611 for whether the password inputted at step 610 matches the password stored in storage of the mode setting means 202. If the passwords do not match at step 611, the operation returns to step 610 according to the arrow No where the system asks the user to input a password again. If the passwords are determined to match at step 611, the system is returned to a normal mode and the operation proceeds to step 602 according to the arrow Yes where the system starts monitoring again.

If different values are set for the first standby/halt function activating time and the second standby/halt function activating time, the same operation as that of the abovementioned screen saver activating time is performed. That is to say, either of the conditions of (A) no signal is detected from an input device within the first standby/halt function activating time or (B) no signal is detected from the palm rest 100 within the second standby/halt activating time is satisfied at step 607, the operation proceeds to step 612 according to the arrow No. In contrast, if either of the conditions of (A) a signal is detected from an input device within the first standby/halt function activating time or (B) a signal is detected from the palm rest 100 within the second standby/halt function activating time is satisfied, the operation proceeds to step 608 according to the arrow Yes.

The flowchart of FIG. 6 has been described assuming that both the screen saver function and the standby function or the halt function are ON. If the screen saver function is set to ON and the standby function or the halt function is set to OFF, the standby/halt function activating time is preferably set to co so that the operation always proceeds according to the arrow Yes from the step 607.

If the screen saver function is set to OFF and the standby function or the halt function is set to ON, the operation is preferably controlled to jump to the step 606 instead of proceeding to the step 602. If both the screen saver function and the standby function or the halt function are set to OFF, the operation of this flowchart is preferably not to be taken from the beginning (Specifically, the system is preferably adapted not to activate the controlling program.).

FIG. 7 is a high level block diagram of a mouse pad 700 provided with a mouse rest of the second embodiment of the present invention. A mouse pad is laid under a mouse to improve usability of the mouse, with the surface processed for facilitating a ball of a mechanical mouse to roll smoothly or with a printed pattern for facilitating an optical mouse to be recognized the movement. A mouse pad is sometimes accompanied by a mouse rest as in the second embodiment of the present invention. The mouse rest is a pad or a cushion used for supporting palms or wrists to relieve fatigue of hands of a user operating a mouse.

A mouse pad 200 of the second embodiment includes a body 701 of a mouse rest which is a mouse pad applying the palm rest 100 according to the first embodiment. That is to say, a piezoelectric sensor 702 is embedded in the body 701. The piezoelectric sensor 702 generates a predetermined signal in response to receiving a pressure when a palm or the like is placed on the body 701 of the mouse pad 700. The signal generated by the piezoelectric sensor 702 is converted into the USB signal form at a converter 703 and received in a computer terminal connected with a USB terminal 705 via a USB cable 704.

FIG. 8 is a diagram showing the mouse pad 700 according to the second embodiment of the present invention in use. The mouse pad 700 according to the second embodiment of the present invention is connected with a USB port of the computer terminal 200. A keyboard 13 and a mouse 14 are connected to PS/2 terminals on the computer terminal 200. A display device 15, which is a liquid crystal display, is connected to an RGB output terminal on the computer terminal 200 The mouse pad 700 is used as lying under the mouse 14. As in the first embodiment, a user of the computer terminal 200 can perform operation such as documentation by operating the keyboard 13 or the mouse 14, for example.

While the user places the palms or the writs on the mouse rest of the mouse pad 700 in operating the mouse 14, current is generated at the piezoelectric sensor by the pressure imposed by hands' weight. Predetermined signals are sent to the computer terminal 200. As in the case of the mouse rest 100 according to the first embodiment, a user often places his hands on the mouse rest of the mouse pad 700 while thinking. Even in such a case, the predetermined signals are sent from the mouse rest of the mouse pad 700 to the computer terminal 200.

The computer terminal 200, the keyboard 13, the mouse 14 and the display device 15 according to the second embodiment of the present invention can be realized in the same configuration as that of the first embodiment of the present invention. As the operation of the system is also basically the same as that for the first embodiment of the present invention and those skilled in the art can easily change the design of the operation of the system in the first embodiment of the present invention to apply it to the second embodiment, the detailed description of the second embodiment will be omitted.

FIG. 9 is a high level block diagram of a laptop computer of the third embodiment of the present invention. As the laptop computer 900 of the third embodiment of the present invention is well-known computer which integrates the keyboard 14, the mouse 14 and the display device 15 of the first embodiment of the present invention and can be easily designed by those skilled in the art, the detailed description of the computer will be omitted.

The laptop computer 900 of the third embodiment of the present invention is provided with a sensor 901 on a palm rest part. A predetermined signal from the sensor 901 is directly communicated to a bus via a dedicated controller instead of connecting a USB port. As the operation performed on the predetermined signal is also basically the same as that for the first embodiment and those skilled in the art can easily change the design of the operation in the first embodiment of the present invention to apply it to the third embodiment of the present invention, the detailed description of the third embodiment will be omitted.

FIG. 10 is a perspective illustration of a pointing device 1000 of the fourth embodiment of the present invention. The pointing device 1000 is assumed to be used with a projector. The pointing device 1000 has a function of performing operation to the projector as well as the equal function of a mouse to a computer terminal.

Specifically, the pointing device 1000 has a button 1003 for moving a pointer on the display device according to the direction and the strength of an applied pressure, a button 1005 with a function corresponding to the left button on a mouse or a button 1004 with a function corresponding to the right button on a mouse, in order to realize the same functions as those of a mouse for operating a computer terminal.

The pointing device 1000 has a power source button for a projector 1006, a menu button for a projector 1007, a button for switching a source of a projector to video input 1008 and a button for switching a source of a projector to visual data from an RGB output terminal of a computer terminal 1009.

Operation performed by a user with the buttons is sent to a projector from a wireless outputting means 1010 or to a computer terminal via a projector in the fourth embodiment of the present invention. It should be noted that a finger rest 1002 is provided as a rest part for a user to rest fingers while the user is not operating the computer terminal.

FIG. 11 is a side view of the pointing device 1000 of the fourth embodiment of the present invention. The finger rest 1002 of the pointing device 1000 of the fourth embodiment is provided with an optical sensor 1011. The optical sensor 1011 emits infrared radiation 1012 so that it can detect that the infrared radiation 1012 is blocked by user's fingers or the like placed on the finger rest 1002. When the optical sensor 1011 detects that the infrared radiation 1012 is blocked, it generates a predetermined signal. The predetermined signal generated by the optical sensor 1011 is received by the computer terminal from the wireless outputting means 1010 via a wireless connection.

FIG. 12 is a diagram showing a presentation system of the fourth embodiment of the present invention. The system according to the fourth embodiment includes a laptop computer 1201, a projector 1204 and a screen 1205.

The laptop computer 1201 has a function of sending data of a visual image to the projector 1204 via a cable 1202 connected to the RGB outputting terminal. The visual image received by the projector 1204 is projected on the screen 1205. The user can switch plural slides by operating the pointing device 1000.

Specifically, user's operation is sent out from the wireless outputting unit 1011 of the pointing device 1000 as a signal and received by the projector 1204. The signal received by the projector 1204 is received by the laptop computer 1201 via a USB cable 1203 connected with the USB terminal of the laptop computer 1201.

The laptop computer 1201, the projector 1204 the screen 1205 and the like according to the fourth embodiment of the present invention can be realized by well-known products in consideration with the first embodiment of the present invention. As the operation of the system is also basically the same as that for the first embodiment of the present invention and those skilled in the art can easily change the design of the operation of the system in the first embodiment of the present invention to apply it to the fourth embodiment, the detailed description of the fourth embodiment will be omitted.

A scenario of the fourth embodiment of the present invention will be described. A storage device of the laptop computer 1201 stores an electronic presentation material created by Microsoft® Power Point or the like. A user can replay the presentation material by double clicking a mouse button on an icon of the presentation material present on the desktop.

While a user is performing a presentation, an index finger of the user is often placed on the button 1005 in order to operate the pointing device 1000. The presentation is often suspended, however, when the user is asked a question during the presentation.

In conventional arts, if a Q&A session (questions and answers) lasts long and time passes, a screen saver function or a standby function or a halt function is sometimes activated when the user does not intend it to. In such a case, the user is often required to input a password or wait for rebooting to resume the presentation. This devalued the presentation.

In the fourth embodiment of the present invention, however, the pointing device 1000 has a finger rest 1002 and an index finger of a user usually moves to the finger rest 1002 provided as a rest part so as not to press the button 1005 (see FIG. 13) When the user's index finger moves to the finger rest 1002, the finger blocks the infrared radiation 1012 and the optical sensor 1011 generates a predetermined signal. The generated predetermined signal prevents the laptop computer 1201 from entering into the security mode or the power saving mode. Therefore, in the fourth embodiment of the present invention, a user can easily avoid troubles in resuming a presentation, which were required in conventional arts.

It is easily understood that electronic equipment, which operates in two or more modes including a normal mode, a security mode and/or power saving mode, can be effectively controlled according to the present invention.

The present invention has been described by using the embodiments of the present invention; however, a technical range of the present invention is not limited to the range described in the abovementioned embodiments. Although a piezoelectric sensor is described in the first, second, and third embodiments, a thermal sensor, an optical sensor or the other various sensors or combinations of them can be used for recognizing a part of a user's body placed on the rest part. In contrast, an optical sensor is described in the fourth embodiment, a piezoelectric sensor, a thermal sensor or the other various sensors or combinations of them can be used.

It is apparent for those skilled in the art that various modifications and improvements can be added to the abovementioned embodiments. Accordingly, it is a matter of course that embodiments with such modifications and improvements are included in a technical range of the present invention.

### BRIEF DESCRIPTION OF THE DRAWINGS

FIG. 1 is a high-level block diagram of a palm rest 100 according to the first embodiment of the present invention;

FIG. 2 a diagram showing a system according to the first embodiment of the present invention;

FIG. 3 is a diagram illustrating an example of a hardware configuration of the computer terminal 20 preferable to connect with the palm rest 100 according to the first embodiment of the present invention;

FIG. 4 is a functional block diagram of a system of the first embodiment of the present invention;

FIG. 5 is a flowchart showing a flow of setting operation of parameters in a system of the first embodiment of the present invention;

FIG. 6 is a flowchart showing operation of a system according to the first embodiment of the present invention;

FIG. 7 is a high level block diagram of a mouse pad 700 of the second embodiment of the present invention;

FIG. 8 is a diagram showing the mouse pad 700 according to the second embodiment of the present invention in use;

FIG. 9 is a high level block diagram of a laptop computer of the third embodiment of the present invention;

FIG. 10 is a perspective illustration of a pointing device 1000 of the fourth embodiment of the present invention;

FIG. 11 is a side view of the pointing device 1000 of the fourth embodiment of the present invention;

FIG. 12 is a diagram showing a presentation system of the fourth embodiment of the present invention; and

FIG. 13 a diagram showing the pointing device 1000 according to the second embodiment of the present invention in use.

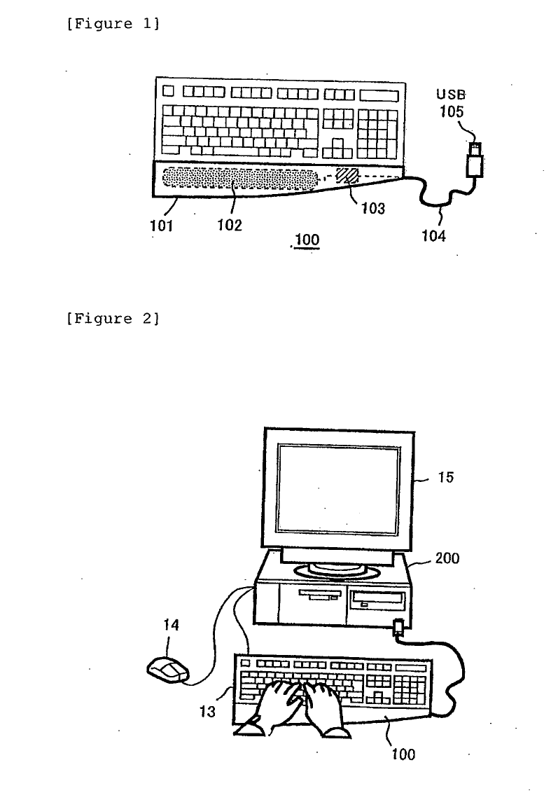

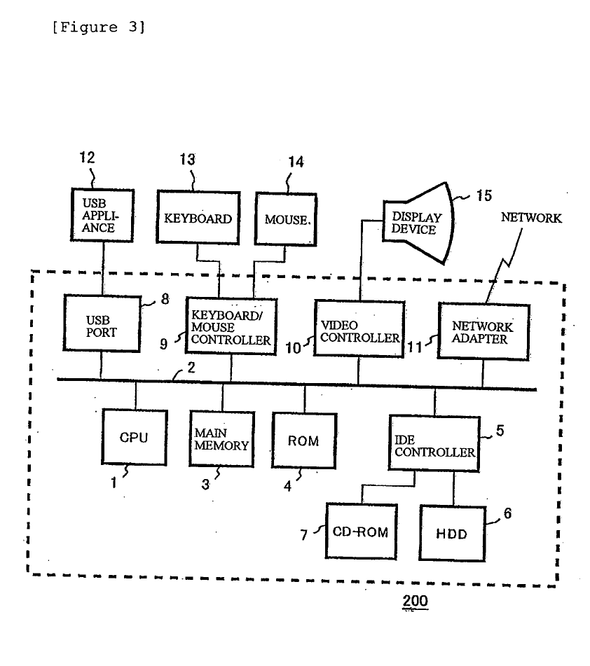

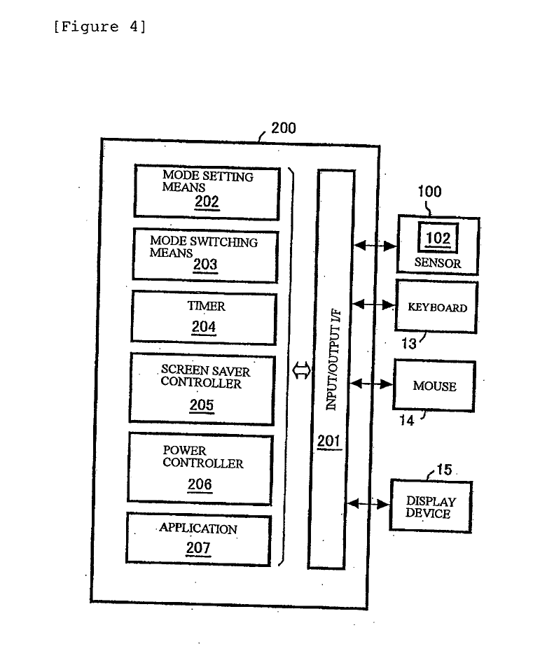

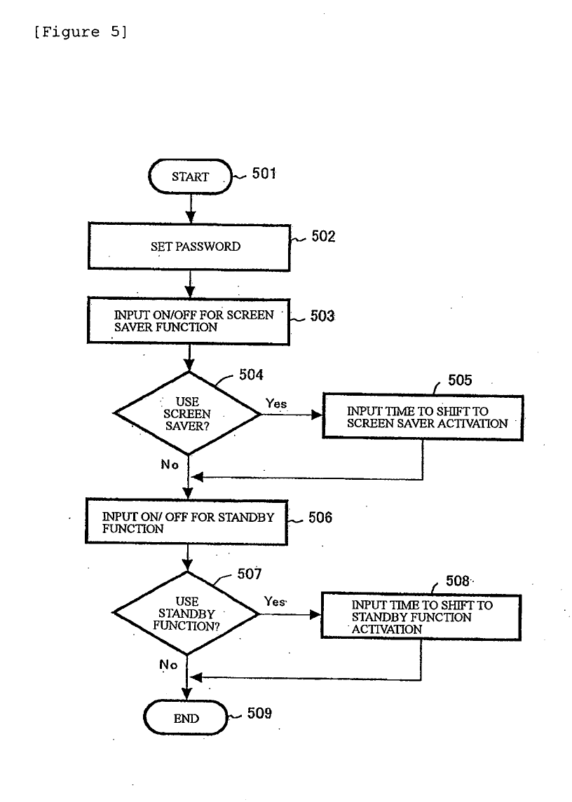

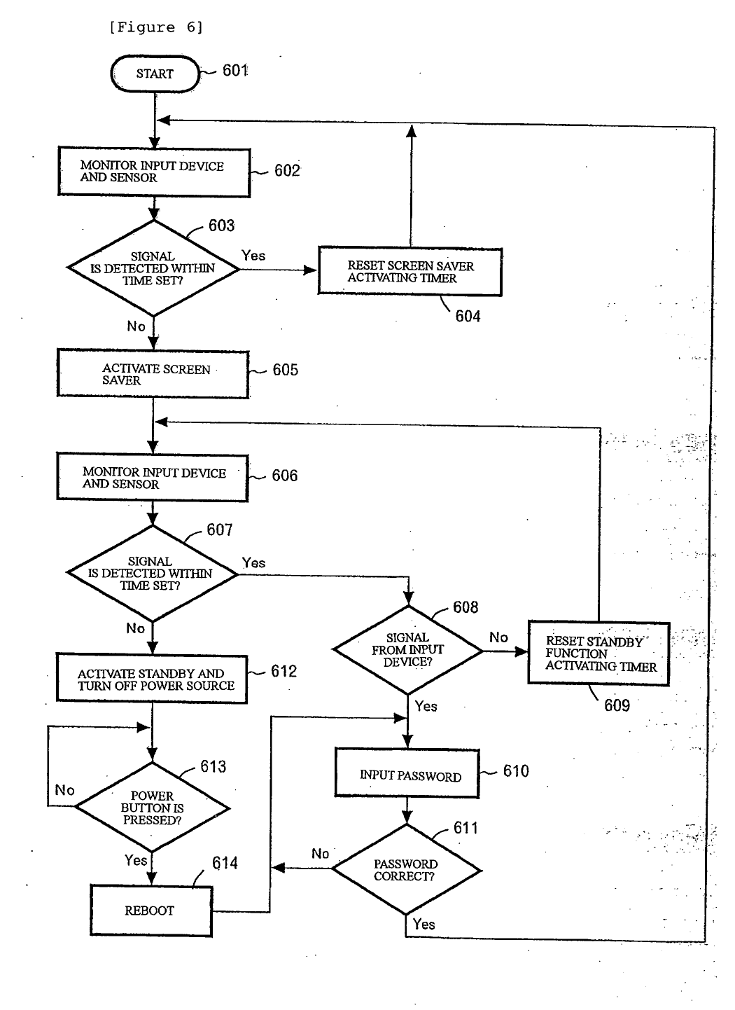

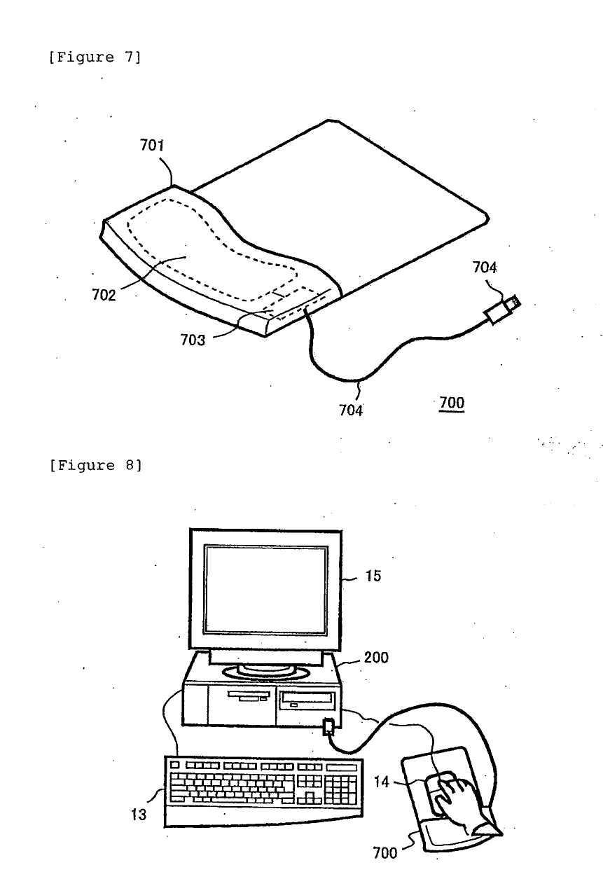

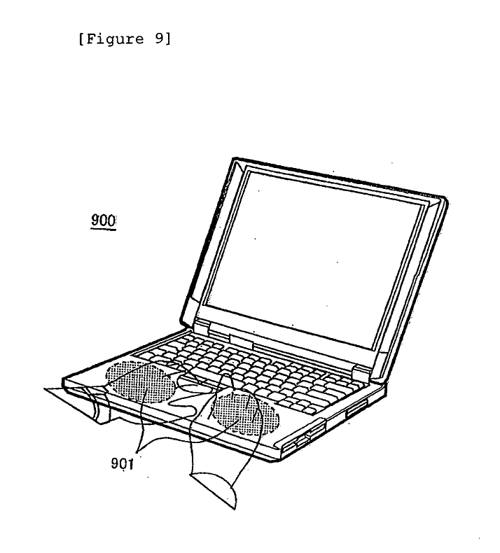

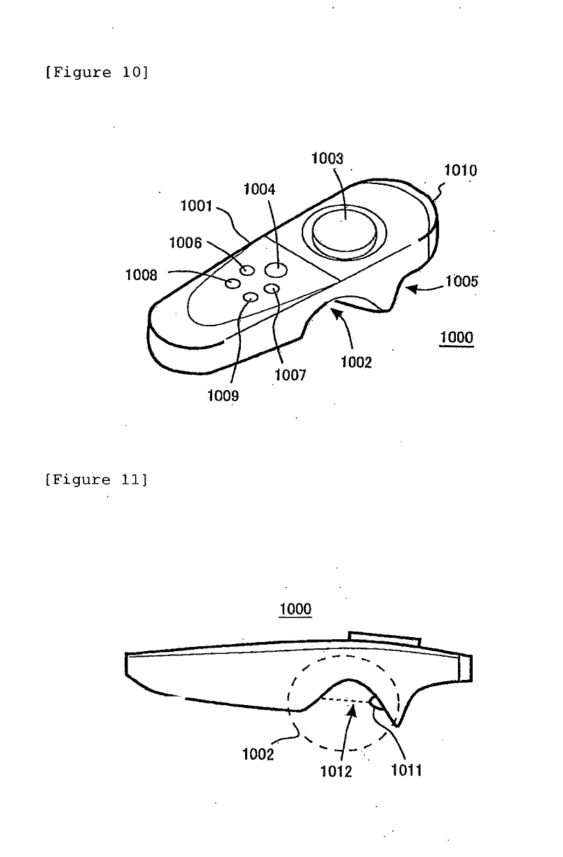

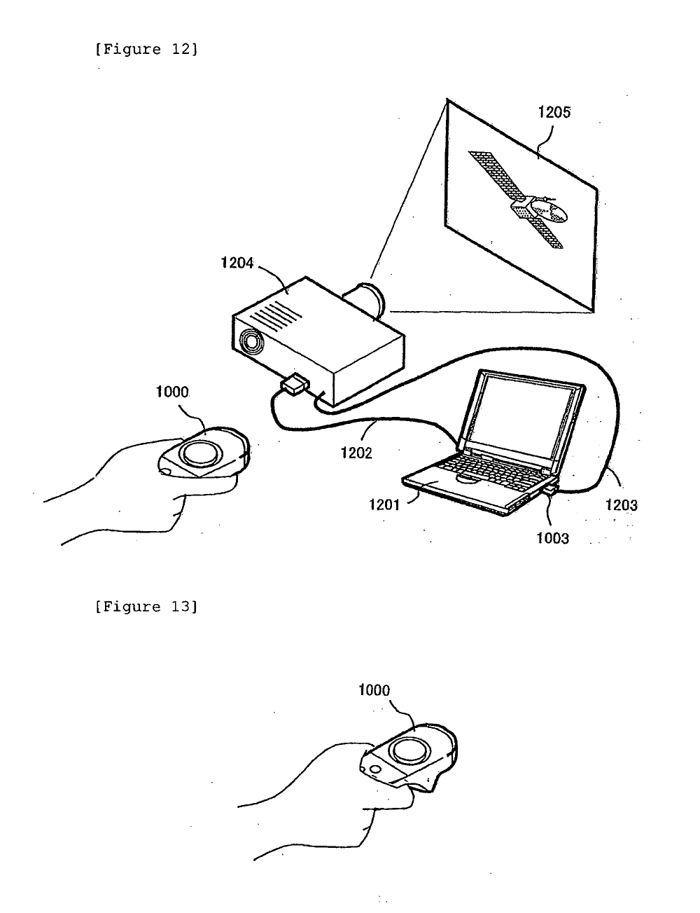

1. Apparatus comprising:
electronic equipment which operates in two or more modes including (A) a normal mode and (B) a security mode and/or a power saving mode and includes an input device which inputs information into the electronic equipment by a person performing an operation, the electronic equipment comprising:
a sensor which is disposed in a rest portion of the input device and which generates a predetermined signal in response to a detection that a part of the body of the person performing the operation rests on the rest portion; and
a signal generator for generating a signal to instruct the electronic equipment not to shift to the security mode and/or power saving mode based on the predetermined signal generated by the sensor.

2. Apparatus according to claim 1, wherein:
the electronic equipment is a computer device;
the input device is a keyboard for operating the computer device; and
the sensor is disposed in a palm rest of the keyboard.

3. Apparatus according to claim 1, wherein:
the electronic equipment is a computer device;
the input device is a mouse for operating the computer device; and
the sensor is disposed in a mouse rest of the mouse.

4. Apparatus according to claim 1, wherein:
the electronic equipment is a laptop computer; and
the sensor is disposed in a palm rest of a keyboard of the laptop computer.

5. Apparatus according to claim 1, wherein:
the electronic equipment is a computer device; and
the input device is a remote controller for operating the computer device.

6. Apparatus according to claim 5, wherein:
the remote controller includes a finger rest; and
the sensor is disposed in the finger rest.

7. Apparatus according to claim 1, wherein the sensor is any one or a combination of a pressure sensor, a temperature sensor and an optical sensor.

8. Apparatus according to claim 2, wherein the signal generated by the sensor is transmitted via USB (Universal Serial Bus) connection to the electronic equipment.

9. Apparatus according to claim 1, wherein the signal generated by the sensor is transmitted via wireless connection to the electronic equipment.

10. Apparatus according to claim 1, wherein the security mode is implemented by a screen lock function.

11. Apparatus according to claim 1, wherein the power saving mode is a standby function or a pause function.

12. Apparatus according to claim 1, wherein the security mode and power saving mode are implemented by a standby function or a pause function each with a lock function.

13. Apparatus according to claim 1, wherein:
the electronic equipment comprises a timer; and
the electronic equipment shifts from the normal mode to the security mode and/or power saving mode in response that it is measured by the timer that the signal from the input device or the sensor is not detected for a predetermined period of time.

14. Apparatus according to claim 13, wherein the timer is reset based on the signal from the input device or the sensor.

15. Apparatus according to claim 1, wherein:
the electronic equipment comprises a timer;
the electronic equipment shifts from the normal mode to the security mode and/or power saving mode in response to that (A) it is measured by the timer that the signal from the input device is not detected for a first predetermined
period of time or (B) it is measured by the timer that the signal from the sensor is not detected for a second predetermined period of time.

16. A method comprising:
controlling electronic equipment operating on two or more kinds of modes including (A) a normal mode and (B) a security mode and/or power saving mode, wherein the electronic equipment includes an input device for inputting information into the electronic equipment by a person performing an operation;
generating a predetermined signal in response to a detection that a part of the body of the person performing operation rests on a rest portion of the input device; and
generating a signal to instruct the electronic equipment not to shift to the security mode and/or power saving mode, based on the predetermined signal.

17. A product comprising:
a computer usable medium having computer readable program code stored thereinfor controlling electronic equipment operating on two or more kinds of modes including (A) a normal mode and (B) a security mode and/or power saving mode, wherein the electronic equipment includes an input device for inputting information into the electronic equipment by a person performing an operation, the computer readable program code in said product being effective to:
generating a predetermined signal in response to a detection that a part of the body of the person performing operation rests on a rest portion of the input device; and
generating a signal to instruct the electronic equipment not to shift to the security mode and/or power saving mode, based on the predetermined signal.
